(19) United States
(12) Patent Application Publication
(10) Pub. No.: US 2014/0100904 A1
(43) Pub. Date: Apr. 10, 2014

(54) ADAPTIVE REMINDER STRATEGIES FOR USER ACTIVITIES

(71) Applicants: James Louis Wolf, Pine, CO (US); Franz Friedrich Huber, Denver, CO (US); Keith Amann, Westminster, CO (US)

(72) Inventors: James Louis Wolf, Pine, CO (US); Franz Friedrich Huber, Denver, CO (US); Keith Amann, Westminster, CO (US)

(21) Appl. No.: 14/045,431

(22) Filed: Oct. 3, 2013

Related U.S. Application Data
(60) Provisional application No. 61/709,506, filed on Oct. 4, 2012.

(51) Int. Cl. G06Q 10/10

(52) U.S. Cl. CPC G06Q 10/1095
USPC 705/7.19

(57) ABSTRACT

Embodiments herein describe system and methods for adaptive reminders of user activities. In one embodiment, an adaptive reminder system identifies a start time for a user activity, determines a priority of the activity, and determines a flexibility in the start time. The adaptive reminder system calculates a time at which to remind the user of the activity based on the start time, the priority, and the flexibility in the start time, and generates a notification at the calculated time to remind the user of the activity.

### CROSS REFERENCE TO RELATED APPLICATIONS

This document claims priority to U.S. Provisional Patent Application No. 61/709,506 (filed on Oct. 4, 2012) entitled INTERACTIVE DAILY LIVING SUPPORT SYSTEM WITH ACTIVITY RECOGNITION AND LOCATION AWARENESS, which is hereby incorporated by reference.

### FIELD

This disclosure relates to the field of electronic reminders of user activities.

### BACKGROUND

A large segment of elderly or disabled persons who would otherwise require institutional medical care are able to live independently as long as assistance with their daily living activities and monitoring of their condition is provided. Autonomous assistance and remote care, while such persons live independently, can be preferred by the patients. Further, this type of patient environment is less expensive than care in a professional setting.

Patients often have a number of daily activities that must be accomplished in order to live independently. For example, the patients may have medication schedules, meal schedules, doctor appointments, etc., each of which have varying degrees of importance in an overall strategy of independent living. If, for example, a patient misses a daily dose of aspirin, this may be less detrimental to successful independent living than missing a chemotherapy appointment.

It is often insufficient to simply provide an electronic calendar system to patients in an independent living environment because such systems often lack the flexibility and adaptability to ensure the long-term successes of such patients. In view of the above discussion, problems remain for ensuring that user activities are implemented effectively.

### SUMMARY

Embodiments described herein provide adaptive reminder strategies for user activities that are based on a priority of the activity and the flexibility in the start time for the activity. Generally, higher priority activities, such as important medications or medical appointments are treated differently than lower priority activates, such as laundry or cleaning. In an independent living environment for patients, such adaptive reminder strategies are more effective in ensuring that patients accomplish activities which are more likely to result in the ability of the patient to continue to live in an independent environment.

One embodiment is an adaptive reminder system that includes a display and a processor. The processor is adapted to identify a start time for a user activity, to determine a priority of the activity, and to determine a flexibility in the start time. The processor is further adapted to calculate a time at which to remind the user of the activity based on the start time, the priority, and the flexibility in the start time, and to generate a notification at the calculated time utilizing the display to remind the user of the activity.

Another embodiment is a method of adaptively reminding a user of an activity. The method comprises identifying a start time for an activity, determining a priority of the activity, and determining a flexibility in the start time. The method further comprises calculating a time at which to remind the user of the activity based on the start time, the priority, and the flexibility in the start time. The method further comprises generating a notification at the calculated time utilizing a display to remind the user of the activity.

Another embodiment is a non-transitory computer readable medium. The medium includes programmed instructions which, when executed by a processor, direct the processor to identify a start time for a user activity, to determine a priority of the activity, and to determine a flexibility in the start time. The instructions further direct the processor to calculate a time at which to remind the user of the activity based on the start time, the priority, and the flexibility in the start time. The instructions further direct the processor to generate a notification at the calculated time utilizing a display to remind the user of the activity.

The features, functions, and advantages that have been discussed can be achieved independently in various embodiments or may be combined in yet other embodiments further details of which can be seen with reference to the following description and drawings.

### DESCRIPTION OF THE DRAWINGS

Some embodiments are now described, by way of example only, and with reference to the accompanying drawings. The same reference number represents the same element or the same type of element on all drawings

FIG. 1 is an illustration of an adaptive reminder system in an exemplary embodiment.

FIG. 2 is a block diagram of a user activity in an exemplary embodiment.

FIG. 3 is a flow chart illustrating a method of adaptively reminding a user of an activity in an exemplary embodiment.

FIG. 4 is a flow chart illustrating additional steps of the method of FIG. 3 in an exemplary embodiment.

FIG. 5 illustrates a processing system operable to execute a computer readable medium embodying programmed instructions to perform desired functions in an exemplary embodiment.

### DESCRIPTION

The figures and the following description illustrate specific exemplary embodiments. It will thus be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure, and are to be construed as being without limitation. As a result, this disclosure is not limited to the specific embodiments or examples described below, but by the claims and their equivalents.

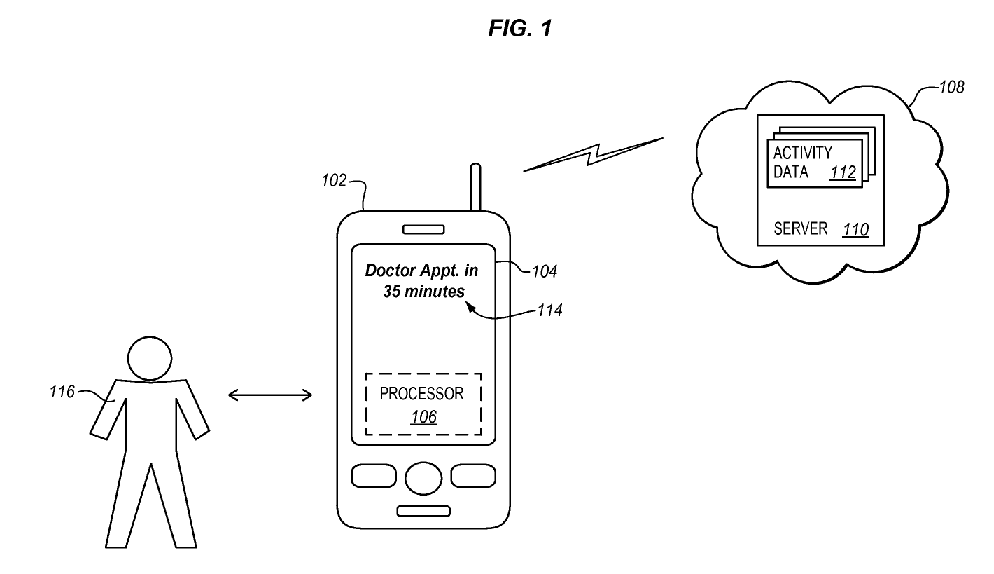

FIG. 1 is an illustration of an adaptive reminder system 102 in an exemplary embodiment. In this embodiment, system 102 includes a display 104. Display 104 includes any component, system, or device that is able to visually display information to a user 116. Some examples of display 104 include Liquid Crystal Displays (LCDs), Plasma Display Panels (PDPs), Organic Light-Emitting Diode (OLED) displays, etc.

System 102 in this embodiment also includes a processor 106. Processor 106 includes any component, system, or device that is able to execute instructions in order to provide reminders to user 116 regarding activities. Some examples of processor 106 include the ARM Cortex-A9, the Intel Atom, the Qualcomm Snapdragon 800, etc.

Although system 102 in FIG. 1 is illustrated in the form of a Personal Data Assistant (PDA) in this embodiment, system 102 may be embodied in other forms as a matter of design choice. Some examples of other embodiments of system 102 include tablet computers, desktop computers, dedicated adaptive reminder appliances (e.g., badges, pagers, pendants, watches, etc.).

In prior reminder systems, reminders for activities are often generated at fixed times relative to the activity time. For instance, if a meeting request is created in Microsoft Outlook for 3 PM, a reminder can be set for 15 min prior, 30 minutes prior, etc. This type of reminder system can be insufficient in some cases. For example, patients in an independent living situation often face a number of challenges in attempting to successfully accomplish the activities which ensure that they in fact, remain mostly independent from institutionalized care. Such activities may include complicated medication schedules, doctor appointments, regular meals, etc., which may be difficult to complete effectively when simple fixed-time reminders are used. For instance, if continued independent living is predicated upon the patient meeting with a particular doctor each week, then some means of increasing the likelihood of the patient reaching the meeting on time would necessarily improve the chances that the patient may in fact, remaining in an independent living environment.

Generally, system 102 provides adaptive reminding for activities based on a number of factors for an activity such as the priority of an activity (e.g., a high priority doctor's appointment versus a low priority laundry activity), and the flexibility in the start time for the activity (e.g., a doctor's appointment cannot move in time, but a meeting with friends may be flexible within about 15 minutes of the start time). Providing an adaptive reminding strategy in contrast to a more fixed-time reminder helps to improve the likelihood that the activity will be accomplished successfully.

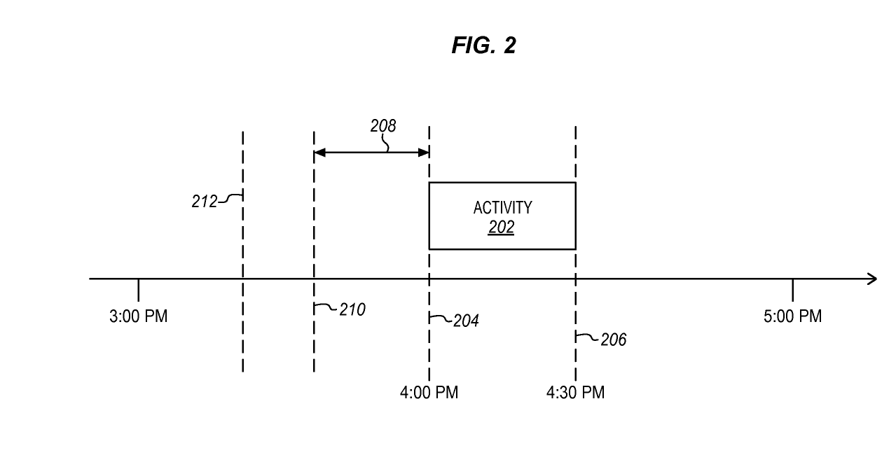

FIG. 2 is a block diagram of a user activity 202 in an exemplary embodiment. In this embodiment, activity 202 has been configured for user 116 (e.g., by user 116 and/or by a caregiver for user 116) to have a start time 204 of 4:00 PM and an end time 206 of 4:30 PM (i.e., activity 202 is scheduled to last about 30 minutes.). Activity 202 may be stored remotely on server 110 as part of activity data 112, and synchronized with system 102 via a wireless communication channel via network 108 to server 110. Network 108 may be a local network (e.g. Ethernet), the Internet, or some other type of communication network. Storing activity data 112 at server 110 may allow user 116 to utilize a number of different devices to review, and be informed of, activities (e.g., activity 202).

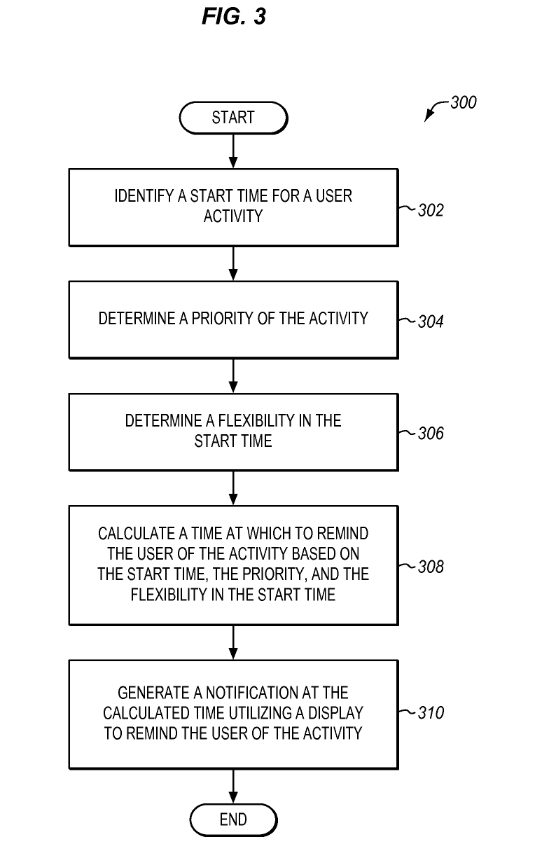

During operation, system 102 analyzes activity 202 for user 116 in order to determine when to issue reminder(s) for activity 202. System 102 may review activity data 112, which may reside wholly or in part on server 110, and processor 106 may identify start time 204 for activity 202, as illustrated in step 302 of FIG. 3. FIG. 3 is a flow chart illustrating a method 300 of adaptively reminding a user of an activity in an exemplary embodiment. The steps of method 300 will be described with respect to system 102 of FIG. 1, although one skilled in the art will understand that method 300 may be performed by other systems not shown. The steps of the methods described herein are not all inclusive and may include other steps not shown. The steps may also be performed in an alternative order.

Processor 106 determines a priority of activity 202 (see step 304 of FIG. 3). Generally, the priority of activity 202 relates to an importance of activity 202. Some activities may be more important than other activities, where the importance of an activity relates to the consequences of skipping the activity. For instance, a doctor's appointment activity may have a higher priority than a meal, as skipping a doctor's appointment may have significant consequences for user 116. Some example categories of priorities for an activity include “critical”, “cannot miss”, “can be rescheduled”, and “optional”. A “critical” priority indicates if an activity is not completed at a specified time, then strong negative consequences are expected (e.g., missing a medication). A “cannot miss” priority indicates an important activity that should occur at the scheduled time. A “can be rescheduled” priority indicates that an activity is important, but that it is acceptable to reschedule the activity to a new time. An “optional” priority for an activity indicates that missing the scheduled time for the activity has little or no negative consequences. The priority of activity 202 may be set by user 116 and/or a caregiver for user 116. Although a particular set of categories has been discussed, one skilled in the art will understand that any number of possibilities exist for relating the priorities of one activity over another activity.

In addition to determining start time 204 and a priority for activity 202, processor 106 also determines a flexibility 208 in start time 204 for activity 202 (see step 306 of FIG. 3). Flexibility 208 generally relates to how timely user 116 should be for activity 202. For example, user 116 may be able to still accomplish a doctor's visit if 15 minutes early for the appointment, but may be prevented from seeing the doctor if user 116 is 15 minutes late for the appointment. However, user 116 may be able to still accomplish a laundry task even if the task is performed sometime within a few hours of the scheduled time. Some example categories of flexibility 208 include “must be on time”, “try to be on time”, “can be late”, or “none”. “Must be on time” indicates that being late (or early) may prevent the activity from being completed. “Try to be on time” indicates that negative social consequences of being late exist for the activity, but that the activity can still be completed. “Can be late” indicates that little or no negative consequences exist for being late. “None” indicates that the start time (e.g., start time 204 of activity 202) is of no consequence. For instance, a laundry activity may have a start time, but user 116 could do laundry at almost any time during the day.

Processor 106 then calculates a time 212 at which to remind user 116 of activity 202 based on start time 204 for activity 202, the priority of activity 202, and flexibility 208 of activity 202 (see step 308 of FIG. 3). Time 212 is illustrated in FIG. 2 as being calculated before start time 204 (i.e., before 4:00 PM), although this may not always be the case. For instance, if the priority of activity 202 is low and/or if flexibility 208 is high, then time 212 may occur after start time 204. One example of this is for a low priority highly flexible laundry task. In this case, processor 106 may calculate time 212 as occurring after the scheduled time as the scheduled time may have little or no importance.

In response to calculating time 212, processor 106 generates a notification 114 (see FIG. 1) at time 212 on display 104 to remind user 116 of activity 202 (see step 310 of FIG. 3). The notification may be via text (e.g., Short Message System (SMS) messages), email, graphical objects, etc., presented on display 104. In some embodiments, notification may also be provided via voice interactions, telephone calls, etc., to user 116.

Notification 114 provides information regarding activity 202, and in this embodiment notification 114 displays “Doctor Appt. in 35 minutes” to user 116. Also note that notification 114 is provided to user at time 212. This allows user 116 to act regarding activity 202 at time 212 in contrast to providing user 116 with a list of activities for an entire day at once. This also allows user 116 to specifically perform actions regarding activity 202 at time 212, such as travelling to a remote location for a doctor's appointment, preparing a meal, finding medications, etc. In cases where user 116 is a patient or is elderly, providing notification 114 at time 212 is more likely to ensure that user 116 takes whatever actions are necessary to accomplish activity 202 rather than being overwhelmed with a number of activities which may not have to be accomplished until later.

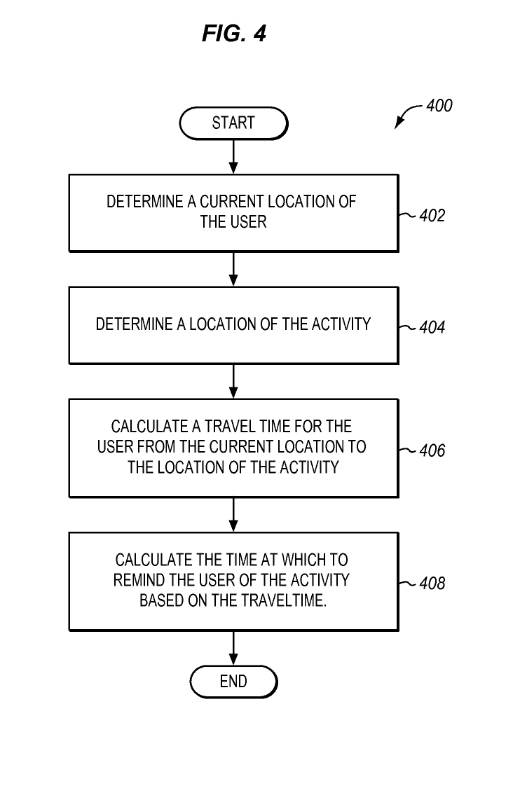

If accomplishing activity 202 involves travel to another location for user 116, then processor 106 may additionally modify time 212 to account for travel to another location by user 116. This is an optional embodiment, and is illustrated in FIG. 4 as a flow chart illustrating additional steps of method 300 of FIG. 3 in an exemplary embodiment.

When travel may be necessary to accomplish activity 202, processor 106 adjusts time 212 accordingly to provide sufficient time for user 116 to travel. To do so, processor 106 may first determine a current location of user 116 (see step 402 of FIG. 4). Determining the current location of user 116 may be performed using the Global Positioning System (GPS) if user 116 is out of the home and travelling, may be performed by locating a cell tower proximate to system 102, by locating a Wi-Fi hot spot proximate to system 102, etc. Processor 106 may then determine a location of activity 202 (see step 404 of FIG. 4). The location of activity 202 may be pre-determined by user 116 and/or a caregiver. For instance, an address of a doctor's appointment may be entered when creating activity 202. Thus, activity data 112 associated with activity 202 may include the destination address for activity 202.

Processor 106 then calculates a travel time for user 116 from the current location to the location of activity 202 (see step 406 of FIG. 4). The travel time may account for user 116 walking, driving, and/or being driven to the location of activity 202. Travel time may include traffic delays, bus schedules, enough lead time for user 116 to contact a third party for a ride, etc.

In response to processor 106 calculating a travel time for user 116, processor 106 may then adjust time 212 (see FIG. 2) to account for the travel time. For instance, if 30 minutes of travel time is calculated, then the processor 106 may move time 212 from about 3:20 PM illustrated in FIG. 2 to before 3:00 PM to account for the additional time necessary for user to travel to a location for activity 202. This ensures that sufficient time exists for user 116 to reach a location for activity 202.

In some cases, user 116 may fail to complete activity 202 prior to end time 206. For instance, after end time 206 has passed, processor 106 may determine that user 116 did not complete activity 202. User 116 may have never reached the location of activity 202; user 116 may have marked activity 202 as not completed after end time 206 has passed, etc. Processor 106 may then notify a third party that user 116 has failed to complete activity 202. Processor 106 may provide the notification to the third party in a number of different ways, including email, text messages, telephone calls, etc. Processor 106 may also attempt to re-schedule activity 202 if activity 202 is not completed. For example, processor 106 may attempt to re-schedule activity 202 later in the day, the next day, the next week, etc.

Providing an adaptive reminder strategy to user 116 increases the chances that user 116 will perform the activities successfully, and is an improvement on the fixed-time type of reminding systems. In cases where user 116 is an at-home patient, an adaptive reminder strategy can ensure that user 116 is more likely to be successful in remaining in the home.

### EXAMPLE

Consider the following example. A patient in a home-care setting is provided an adaptive reminder system and a caregiver is assigned to the patient. The caregiver generates a number of activities for the patient, which is synchronized with the adaptive reminder system. The caregiver may generate meal reminders, medication reminders, doctor appointments, etc., for the patient. For purposes of this example we will consider that the caregiver has generated an activity for the patient to take Coumadin at 9 AM each morning. The caregiver sets up this activity as a high priority activity. Further, the caregiver assigns a flexibility for this activity as +/−30 minutes from the star time, which indicates that the activity generally can be performed on or around the scheduled 9 AM time. The caregiver then assigns an end time for the activity as 10 PM. Thus in this case, taking Coumadin by the patient is an important activity which, if the patient fails to do so, could jeopardize the patient's ability to remain in a home-care environment. However, there is a certain amount of flexibility in the time that the patient takes Coumadin, which may be specified by the patient's doctor.

During the morning, the adaptive reminder system reviews the Coumadin activity in order to determine at which time to issue the notification for taking Coumadin to the patient. In this case the adaptive reminder system issues the first notification to the patient well before the 9 AM scheduled time (e.g., 8:30 AM). The adaptive reminder system may then issue reminders subsequent to the initial notification that are based on the priority. For instance, the adaptive reminder system may generate reminders every 10 minutes after 8:45 AM (based on the flexibility of +/−15 minutes around the start time) until either the patient snoozes the reminder or the patient indicates that the Coumadin was taken. If the Coumadin activity was marked as a low priority activity, then the adaptive reminder system may increase the reminder interval to 20 minutes or more.

If the patient snoozes the reminders (if allowed by the activity), then the adaptive reminder system suppresses the reminders for a period of time that is based on the flexibility of the activity. In this case, the flexibility is +/−15 minutes, so the adaptive reminder system may only allow the patient to snooze the reminders for 5 minutes or so. If the flexibility was higher (e.g., +/−1 hour), then the adaptive reminder system may have allowed the patient to snooze the reminders for longer, such as 20 minutes or more.

After taking the Coumadin, the patient may mark this activity as completed utilizing the adaptive reminder system. Or, the system may mark the activity as complete automatically. For example, the system may determine that the patient has requested Coumadin from a medication dispensing device; the system may recognize a particular pattern in the patient activity (e.g., locations of the patient and/or movements of the patient) suggesting that the activity is complete, etc. Regardless of whether the system marks the activity as complete or the patient marks the activity as complete, this suppresses further reminders for the Coumadin activity on whatever platform(s) the system is operating. For example, mobile versions of the system, tablet versions of the system, online versions of the system, stand-alone computer versions of the system, etc. Marking the activity as complete may also modify additional tasks. For example, if a medication task is related to a meal task (e.g., the patient is supposed to take medication prior to eating), the system may automatically re-schedule the meal task (e.g., let the meal task slide forward in time) as long as the medication task is still pending.

If the end time had passed and/or the patient had marked the activity as not completed, then the adaptive reminder system contacts the caregiver for the patient and informs the caregiver that the patient has missed the Coumadin activity. This allows the caregiver to intervene and attempt to resolve the issue with the patient. For instance, the caregiver may modify the activity for a different time, may prevent the snooze option by the patient, may reduce the flexibility in the activity in order to modify when the reminders are given (e.g., more often, earlier prior to the start time, etc.), may call the patient via the system, etc.

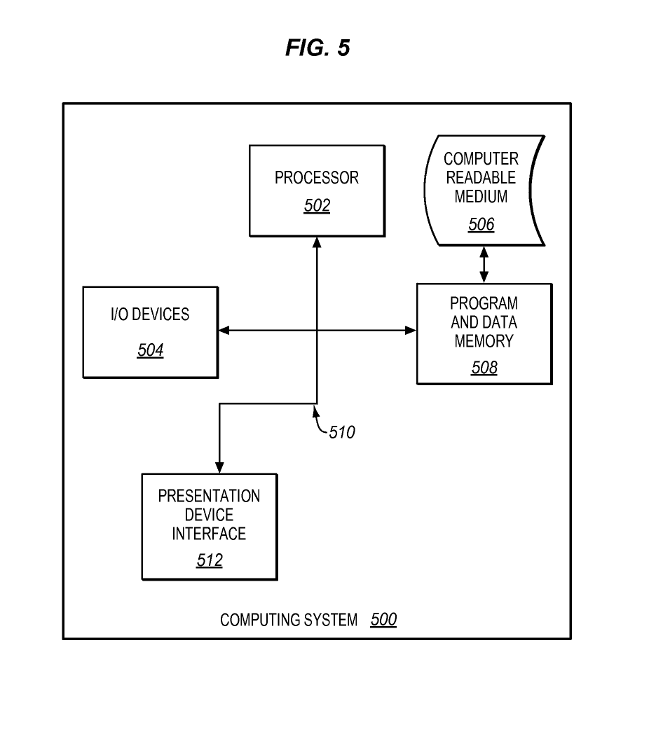

As mentioned, embodiments disclosed herein can take the form of software, hardware, firmware, or various combinations thereof. In one particular embodiment, software is used to direct a processing system to perform the various operations disclosed herein. FIG. 5 illustrates a processing system 500 operable to execute a computer readable medium embodying programmed instructions to perform desired functions in an exemplary embodiment. Processing system 500 is operable to provide the above features by executing programmed instructions and accessing data stored on a computer readable storage medium 506. In this regard, embodiments of the invention can take the form of a computer program accessible via the computer-readable medium 506 providing program code for use by a computer or any other instruction execution system. For the purposes of this description, a computer readable storage medium 506 can be anything that can contain or store the program for use by the computer.

The computer readable storage medium 506 can be an electronic, magnetic, optical, electromagnetic, infrared, or semiconductor device. Examples of the computer readable storage medium 506 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

The processing system 500, being suitable for storing and/or executing the program code, includes at least one processor 502 coupled to memory elements 508 through a system bus 510. The memory elements 508 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 504 (including but not limited to keyboards, displays, pointing devices, etc.) can be coupled to the system either directly or through intervening I/O controllers. Network adapter interfaces may also be coupled to the system to enable the computer system 500 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 512 may be coupled to the system to interface to one or more presentation devices, such as printing systems and displays for presentation of presentation data generated by processor 502.

Although specific embodiments were described herein, the scope is not limited to those specific embodiments. Rather, the scope is defined by the following claims and any equivalents thereof.

1. An apparatus comprising:
a display; and
a processor adapted to identify a start time for a user activity, to determine a priority of the activity, and to determine a flexibility in the start time;
the processor further adapted to calculate a time at which to remind the user of the activity based on the start time, the priority, and the flexibility in the start time, and to generate a notification at the calculated time utilizing the display to remind the user of the activity.

2. The apparatus of claim 1 wherein:
the processor is further adapted to determine a current location of the user, to determine a location of the activity, and to calculate a travel time for the user from the current location to the location of the activity; and
the processor further adapted to calculate the time at which to remind the user of the activity based on the travel time.

3. The apparatus of claim 1 wherein:
the processor is further adapted to calculate a reminder interval based on the priority, and to periodically generate reminders at the reminder interval utilizing the display subsequent to generating the notification at the calculated time.

4. The apparatus of claim 3 wherein:
the processor is further adapted to calculate a snooze time based on the flexibility in the start time, and to suppress reminders during the snooze time.

5. The apparatus of claim 1 wherein:
the processor is further adapted to identify an end time for the user activity, to determine if the user has completed the activity prior to the end time, and to notify a third party responsive to the user not completing the activity.

6. The apparatus of claim 5 wherein:
the processor is further adapted to automatically re-schedule the activity responsive to the user not completing the activity.

7. The apparatus of claim 1 wherein:
the processor is further adapted to determine that the user has completed the activity, to mark the activity as complete, and to cancel the notification for the activity responsive to the activity being marked as complete.

8. A method comprising:
identifying a start time for a user activity;
determining a priority of the activity;
determining a flexibility in the start time;
calculating a time at which to remind the user of the activity based on the start time, the priority, and the flexibility in the start time; and
generating a notification at the calculated time utilizing a display to remind the user of the activity.

9. The method of claim 8 wherein:
the method further comprises:
determining a current location of the user;
determining a location of the activity; and
calculating a travel time for the user from the current location to the location of the activity; and
calculating the time at which to remind the user further comprises:
calculating the time at which to remind the user of the activity based on the travel time.

10. The method of claim 8 further comprising:
calculating a reminder interval based on the priority; and
periodically generating reminders at the reminder interval utilizing the display subsequent to generating the notification at the calculated time.

11. The method of claim 10 further comprising:
calculating a snooze time based on the flexibility in the start time; and
suppressing reminders during the snooze time.

12. The method of claim 8 further comprising:
identifying an end time for the user activity;
determining if the user has completed the activity prior to the end time; and
notifying a third party responsive to the user not completing the activity.

13. The method of claim 12 further comprising:
automatically re-scheduling the activity responsive to the user not completing the activity.

14. The method of claim 8 further comprising:
determining that the user has completed the activity;
marking the activity as complete; and
canceling the notification for the activity responsive to the activity being marked as complete.

15. A non-transitory computer readable medium embodying programmed instructions which, when executed by a processor, direct the processor to:
identify a start time for a user activity;
determine a priority of the activity;
determine a flexibility in the start time;
calculate a time at which to remind the user of the activity based on the start time, the priority, and the flexibility in the start time; and
generate a notification at the calculated time utilizing a display to remind the user of the activity.

16. The non-transitory medium of claim 15 wherein:
the instructions further direct the processor to:
determine a current location of the user;
determine a location of the activity; and
calculate a travel time for the user from the current location to the location of the activity; and
instructions that direct the processor to calculate the time at which to remind the user further comprise instructions to:
calculate the time at which to remind the user of the activity based on the travel time.

17. The non-transitory medium of claim 15, wherein the instructions further direct the processor to:
calculate a reminder interval based on the priority; and
periodically generate reminders at the reminder interval utilizing the display subsequent to generating the notification at the calculated time.

18. The non-transitory medium of claim 17, wherein the instructions further direct the processor to:
calculate a snooze time based on the flexibility in the start time; and
suppress reminders during the snooze time.

19. The non-transitory medium of claim 15, wherein the instructions further direct the processor to:
identify an end time for the user activity;
determine if the user has completed the activity prior to the end time; and
notify a third party responsive to the user not completing the activity.

20. The non-transitory medium of claim 19, wherein the instructions further direct the processor to:
automatically re-schedule the activity responsive to the user not completing the activity.
